(19) United States
(12) Patent Application Publication
(10) Pub. No.: US 2006/0134296 A1
(43) Pub. Date: Jun. 22, 2006

(54) Flavored ice on a stick maker

(76) Inventor: Ching-Yu Lin, Yilan Hsien (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/021,935

(22) Filed: Dec. 22, 2004

(51) Int. Cl. A23G 9/00

(52) U.S. Cl. 426/565

(57) ABSTRACT

A flavored ice on a stick maker has an insulated housing, an ice tray and at least one thermoelectric cooling assembly. The ice tray is mounted inside the insulated housing and has multiple mold recesses formed in the ice tray and multiple ice molds respectively mounted in the mold recesses. The thermoelectric cooling assembly is mounted in the insulated housing against the ice tray. Juice and sticks put into the ice mold, and the thermoelectric cooling assembly freezes the juice in the ice molds to form flavored ice on a stick. The flavored ice on a stick can be any flavor, and the flavored ice on a stick maker allows people who do not have a large enough freezer to make flavored ice on a stick. The flavored ice on a stick does not have any strange smell.

### BACKGROUND OF THE INVENTION

1. Field of the Invention

The present invention relates to a flavored ice on a stick maker, and more particularly to a maker that can make flavored ice on a stick.

2. Description of Related Art

Flavored ice on a stick is a very popular snack especially on hot summer days. There are many different flavors of flavored ice on a stick in the market. However, some people still like to make their own flavored ice on a stick.

A conventional flavored ice on a stick comprises juice and a stick. The juice and the stick are put into a container, and the container is put into a freezer. After the juice freezes, the flavored ice on a stick is done. However, the freezer is not just used to make the flavored ice on a stick but also preserves food. Before the juice freezes, the juice may take on a food smell. After the flavored ice on a stick is done, the smell of the flavored ice on a stick may be very terrible. Therefore, people would not use their home freezer to make flavored ice on a stick.

Further more, some people do not have a freezer large enough to make flavored ice on a stick. For these people, making their own flavored ice on a stick is virtually impossible.

To overcome the shortcomings, the present invention provides a flavored ice on a stick maker to obviate or mitigate the aforementioned problems.

### SUMMARY OF THE INVENTION

The primary objective of the present invention is to provide an improved flavored ice on a stick marker that is able to make any flavor of flavored ice on a stick that people desire, and the flavored ice on a stick will not take on any strange smell.

The flavored ice on a stick maker has an insulated housing, an ice tray and at least one thermoelectric cooling assembly. The ice tray is mounted inside the insulated housing and has multiple mold recesses formed in the ice tray and multiple ice molds respectively mounted in the mold recesses. The thermoelectric cooling assembly is mounted in the insulated housing against the ice tray. Juice and sticks are put into the ice molds, and the thermoelectric cooling assembly freezes the juice in the ice molds to form flavored ice on a stick. The flavored ice on a stick can be any flavor, and the flavored ice on a stick maker allows people who do not have a large enough freezer to make flavored ice on a stick. Furthermore, the flavored ice on a stick will not pick up any smell from the flavored ice on a stick maker.

Other objectives, advantages and novel features of the invention will become more apparent from the following detailed description when taken in conjunction with the accompanying drawings.

### BRIEF DESCRIPTION OF THE DRAWINGS

FIG. 1 is perspective view of a flavored ice on a stick marker in accordance with the present invention;

FIG. 2 is an exploded perspective view of the flavored ice on a stick marker in FIG. 1;

FIG. 3 is a side view in partial section of the flavored ice on a stick marker in FIG. 1;

FIG. 4 is a perspective view of a second embodiment of the flavored ice on a stick marker in accordance with the present invention; and

FIG. 5 is a side view in partial section of the flavored ice on a stick marker in FIG. 4.

### DETAILED DESCRIPTION OF THE PREFERRED EMBODIMENT

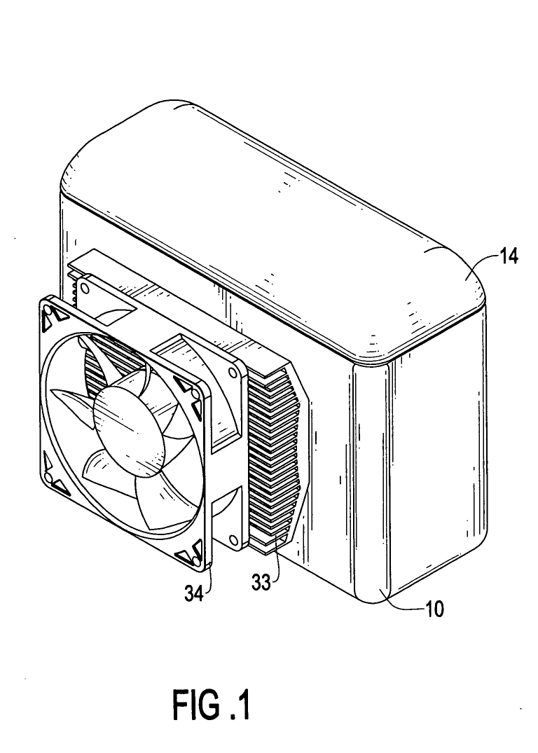

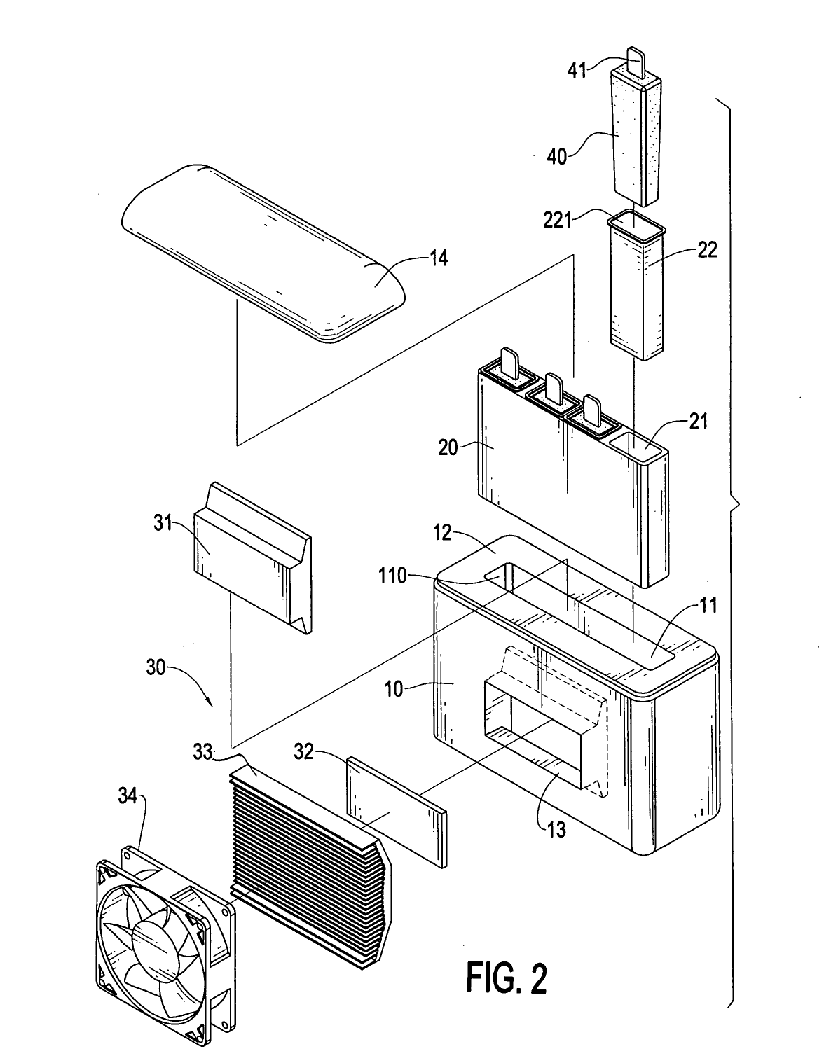

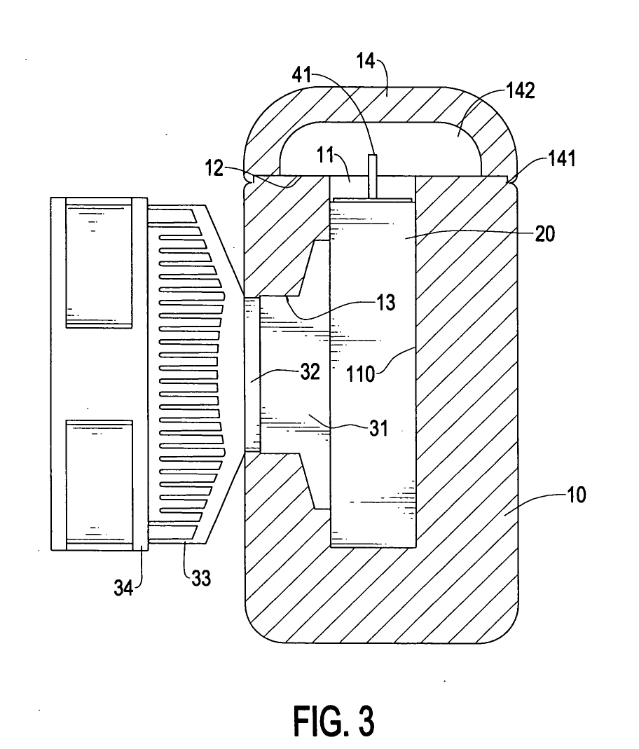

With reference to FIGS. 1, 2 and 3, a flavored ice on a stick maker in accordance with the present invention comprises an insulated housing (10), an ice tray (20) and at least one thermoelectric cooling assembly (30).

The insulated housing (10) is hollow and has a front, a rear, a top surface (12), a top opening (11), a cavity (110), a side opening (13), an optional rear opening (15) and a top cover (14).

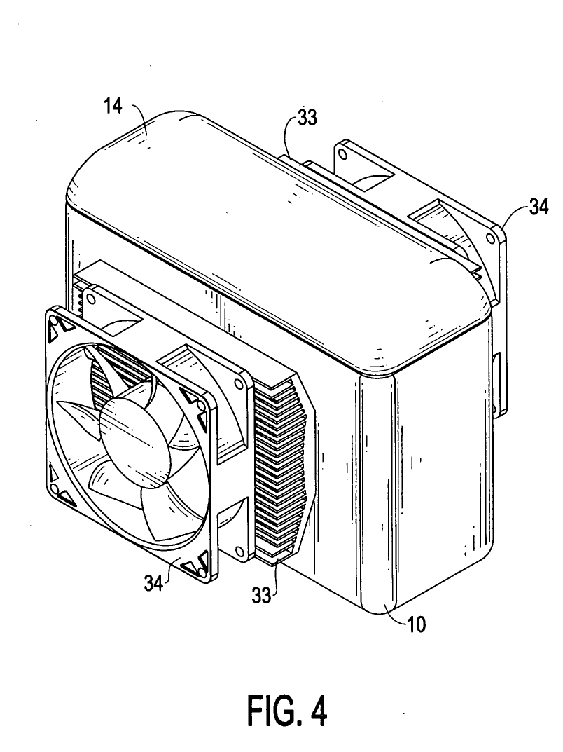

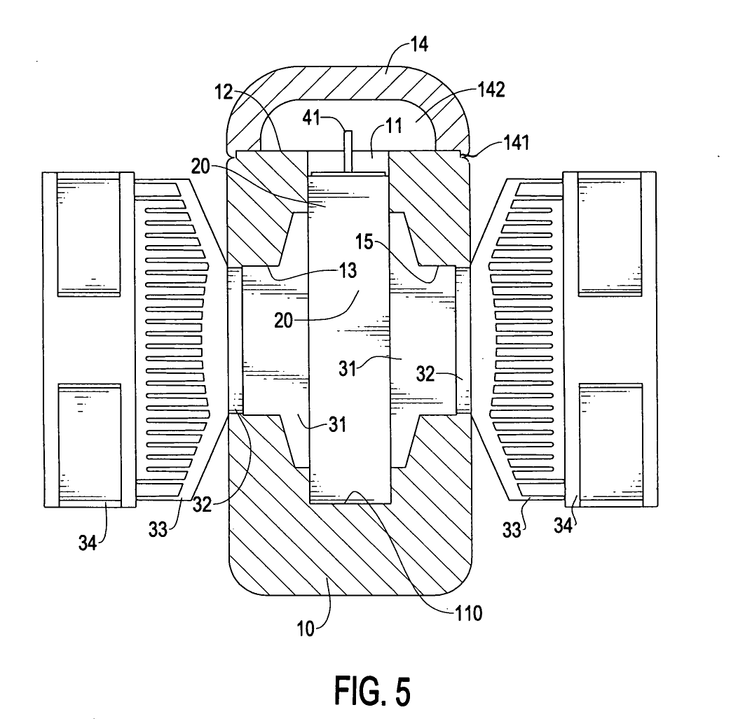

The top surface (12) has an outer edge. The top opening (11) is formed in the top surface (12). The cavity (110) is formed in the insulated housing (10) through the top surface (12) and communicates with the top opening (11). The side opening (13) is formed through the front of the insulated housing (10) and communicates with the cavity (110). With reference to FIG. 4 and 5, a second embodiment of the flavored ice on a stick maker has a rear opening (15) formed through the rear of the insulated housing (10) and communicates with the cavity (110).

The top cover (14) is detachably mounted on and covers the top surface (12) of the insulated housing (10) and has a bottom surface, an outer edge (141) and a domed recess (142). The outer edge (141) is formed on the bottom surface of the top cover (14) and corresponds to the outer edge of the top surface (12) of the insulated housing (10). The domed recess (142) is formed in the bottom surface of the top cover (14) and corresponds to the top opening (11) in the insulated housing (10).

The ice tray (20) is hollow, is mounted in the cavity (110) in the insulated housing (10) and has a top surface, a front, a rear, multiple mold recesses (21) and multiple ice molds (22). The mold recesses (21) are formed inside the ice tray (20) through the top surface. Multiple ice molds (22) are mounted respectively in the mold recesses in the ice tray (20). Each ice mold (22) is a hollow container and has an open top (221).

The thermoelectric cooling assembly (30) is mounted in the front opening (13) of the insulated housing (10) and has a heat conducting block (31), a thermoelectric cooling chip (32), a heat sink (33) and a fan (34). The heat conducting block (31) is mounted through the front of the insulated housing (10) against the front of the ice tray (20) and has an exterior surface. The thermoelectric cooling chip (32) has a cooling surface. The cooling surface is mounted against the exterior surface of the heat conducting block (31) and draws heat from the ice molds (22) through the ice tray (20) and the heat conducting block (31). The heat sink (33) and the fan (34) are mounted sequentially on the thermoelectric cooling chip (32).

With reference to FIGS. 4 and 5, a second thermoelectric cooling assembly (30) may be mounted in the rear opening (15) of the insulated housing (10) and comprises another heat conducting block (31), thermoelectric cooling chip (32), heat sink (33) and fan (34). The heat conducting block (31) is mounted through the rear opening (15) in the insulated housing (10) against the rear of the ice tray (20) and the thermoelectric cooling chip (32), heat sink (33) and fan (34) are sequentially attached to the heat conducting block (31).

To make the flavored ice on a stick, a stick (41) and juice are placed in each ice mold (22), and the ice molds (22) are inserted respectively into the mold recesses (21) in the ice tray (20). The top cover (14) is mounted on and seals the top surface (12) of the insulated housing (10).

The heat drawn from the juice through the ice mold (22), the ice tray (20) and the heat conducting block (31) by the thermoelectric cooling chip (32) to freeze the juice is dissipated by the heat sink (33) and the fan (34). After the juice freezes around the stick (41), the flavored ice on a stick (40) is done. The flavored ice on a stick maker is small enough to be easily carried so people can make flavored ice on a stick (40) anywhere that has a source of power to drive the thermoelectric cooling chip (32). Because the flavored ice on a stick maker is used only to make the flavored ice on a stick (40), the flavored ice on a stick (40) will not pick up any strange smell.

Even though numerous characteristics and advantages of the present invention have been set forth in the foregoing description together with details about the structure and function of the invention, the disclosure is illustrative only. Changes may be made in detail especially in matters of shape, size and arrangement of parts within the principles of the invention to the full extent indicated by the broad general meaning of the terms in which the appended claims are expressed.

What is claimed is:

1. A flavored ice on a stick maker comprising
an insulated housing being hollow and having
a front;
a rear;
a top surface having an outer edge;
a top opening formed in the top surface;
a cavity formed in the insulated housing through the top surface and communicating with the top opening;
a side opening formed through the front of the insulated housing and communicating with the cavity; and
a top cover detachably mounted on and covering the top surface of the insulated housing and having a bottom surface;
a bottom outer edge formed on the bottom surface of the top cover and corresponding to the outer edge of the top surface of the insulated housing; and
a domed recess formed in the bottom surface of the top cover and corresponding to the top opening in the insulated housing;
an ice tray being hollow, mounted in the cavity of the insulated housing and having
a top surface;
a front;
a rear;
multiple mold recesses formed inside the ice tray through the top surface; and
multiple ice molds mounted respectively in the mold recesses in the ice tray, and each ice mold being a hollow container and having an open top; and
a thermoelectric cooling assembly mounted in the front opening of the insulated housing and having
a heat conducting block mounted through the front of the insulated housing against the front of the ice tray and having an exterior surface;
a thermoelectric cooling chip having a cooling surface mounted against the exterior surface of the heat conducting block and drawing heat from the ice molds through the ice tray and the heat conducting block;
a heat sink mounted on the thermoelectric cooling chip; and
a fan mounted on the heat sink.

2. The flavored ice on a stick maker as claimed in claim 1, wherein
the insulated housing has a rear opening formed through the rear of the insulated housing; and
a second thermoelectric cooling assembly is mounted in the rear opening of the insulated housing and comprises
a heat conducting block mounted through the rear opening in the insulated housing against the rear of the ice tray;
a thermoelectric cooling chip attached to the heat conducting block;
a heat sink attached to the thermoelectric cooling chip; and a fan attached to the heat sink.
